(19) United States
(12) Patent Application Publication
(10) Pub. No.: US 2004/0149467 A1
(43) Pub. Date: Aug. 5, 2004

(54) Silvicultural tillage apparatus and method

(76) Inventors: Joseph Melville Gilmer JR., Selma, AL (US); Danny Eugene Craig, Orange Beach, AL (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/293,840

(22) Filed: Nov. 12, 2002

(51) Int. Cl. A01B 21/02

(52) U.S. Cl. 172/542

(57) ABSTRACT

A silvicultural tillage method and apparatus defines access corridors, infiltration zones, and debris filter zones to reduce the environmental insult to a forestry site during tillage and subsequent treatment of a crop tree stand. An articulating blade coupled to a prime mover clears ground debris from a forestry site to define the access corridors and debris filter zones. A tillage gang, incorporating a plurality of star shaped tillage blades is drawn by the prime mover and provides an infiltration zone in which to plant and cultivate the crop trees. The infiltration zone absorbs rain water runoff and particles suspended therein, and providing a water storage reservoir. The access corridors permit narrow band application of fertilizers and herbicides to the infiltration zones, while the preservation of natural vegetative cover within a portion of access corridor and the debris filter zones preserves the natural erosion preventive characteristics of the site.

### FIELD OF THE INVENTION

The present invention relates to an apparatus and method for erosion control and silvicultural operations. More specifically, the present invention relates to a prime moving vehicle equipped with an articulating blade and forestry tiller. The present invention also relates to a method of employing the same which provides for soil and water runoff control, and reduction of greenhouse gas emissions, while reducing the mechanical and chemical preparation requirements for cutover timberland sites. With even more particularity, the articulating blade clears forestry debris into debris filter zones and defines an access corridor while the forestry tiller creates at least one infiltration zone within the access corridor for cultivating crop trees.

### BACKGROUND OF THE INVENTION

The demands of modern forestry require that cut-over timberland sites be managed at intense levels so as to produce maximum growth in the shortest period of time. Many of these intense practices can have a negative impact on erosion, water quality, and greenhouse gas emissions.

There are four components involved in current intensive silvicultural regeneration practices: 1) woody and herbaceous weed elimination; 2) providing forestry site access; 3) elimination of surface compaction and subsurface hardpan layers; and 4) fertilization of crop trees through their growth cycle. Each component provides certain benefits and consequences in terms of forest growth, soil erosion risk, water quality, and greenhouse gas emissions.

The main component of intensive silvicultural regeneration is the elimination of all woody and herbaceous weed competition on a site. In current silvicultural practices this is primarily accomplished by the use of herbicides. After a site is clear-cut but prior to the planting of the crop trees, a chemical treatment is applied on a broadcast basis to the entire site to kill all woody competition. Many times, a fire is used after a chemical treatment to eliminate any remaining competition. During the following spring, after a site is planted, a second chemical treatment is applied to the entire site to eliminate any emerging weeds and grasses. The forestry benefit of this process is that, by eliminating all the competing vegetative cover, all resources, primarily water and nutrients, are made available for use by the crop trees.

The consequences of these practices can lead to significant soil erosion and water quality problems. By eliminating the plants, grasses and scrub, there is no protective canopy cover or developing ground cover. The soil becomes exposed to wind and intense rain penetration. The elimination of active root structures also has a destabilizing effect on soil integrity. Wind and rain will carry off the soil resulting in its loss from the forestry site with concomitant deleterious impact on water quality. Similarly, the loss of vegetation results in a substantial decrease in the site's ability to absorb and evaporate excess water. This reduction in the capacity of the site to retain water will further exacerbate the erosion and runoff problems. Furthermore, the elimination of the vegetation will remove the natural filtration mechanisms provided by the vegetation as well as its ability to slow the velocity of the moving water. All these factors combine during a rain event to produce a high velocity high volume water flow that lifts up the destabilized soil and transports them into the drainage system. The results of herbicide treatment can last up to three years until some species of vegetation other than the crop trees begin to grow back on site. In addition to the excessive soil runoff, the broadcast use of herbicides may also have a negative influence on water quality.

A second component of present intensive silvicultural operations is providing access to the forestry site. Access to the site is necessary to facilitate planting and post planting activities. A combination of two methods is presently employed to provide access to the forestry site, fire and mechanical. Each may be employed in greater proportion to obtain the desired site access.

Due to its low cost, ease of application and quick results, fire has become the preferred method of providing site access. Typically, a fire line is pushed around the entire site before a site preparation fire is started. A hot fire is usually prescribed, which will generally consume all logging debris and any vegetative grow-back. A fire after herbicidal site preparation will normally provide the best results. Mechanical approaches to providing access to a site involve 1) shearing or chopping an entire site, then burning, or 2) shearing a site then raking the debris into windrows.

The forestry benefits of using fire are that debris and trash are burned up. This ensures that planting and subsequent mechanical treatments are not impeded, which results in higher production rates and lower cost. Mechanical methods can also provide excellent access to an entire site, however, they will typically entail higher cost due to the increased mechanical workload and increase the soil compaction on a site.

Fire and mechanical methods of providing site access will produce many of the same erosion and water quality issues as herbicide use. In addition, these methods may exacerbate some of these problems. In the case of fire, the debris has been turned to ash, which has a greater susceptibility to any water runoff event. Moreover, intense fires cause many soils to loose their water infiltration ability. In the case of mechanical preparations, a large amount of soil is exposed due to the bulldozer blade, tracks and root rake pushing debris and dirt. While temporary infiltration benefits may be provided, long term erosion potential is substantially increased.

In further preparing the site for planting crop trees, mechanical means must be employed for the elimination of surface compaction and subsurface hardpan layers. Many soils have upper soil layer compaction. This compaction may be due to prior logging traffic at harvest and/or inherent soil characteristics. Hardpan layers generally exist six to eighteen inches deep in many soils and are similarly influenced by prior logging activities and/or soil characteristics. Mechanical devices are the only means for correcting these problems. In silvicultural operations, this process is loosely referred to as tillage.

On sites that have a high percentage of surface compaction, a large disk is pulled over the site. The soil is turned up and over as the disk cuts down six to twelve inches to improve the surface layer. Hardpan is usually treated by pulling a ripper shank through the hardpan layer. A ripper shank will usually leave a two to four inch gap in the ground. Both conditions may be treated in a single pass by use of a combination plow that rips and beds at the same time. Generally a raised bed is made and the gap made by the ripper is covered.

Disking to eliminate surface compaction provides the forestry benefit of facilitating planting and root growth. Ripping fractures the hardpan and allows crop tree roots to grow downwardly. Bedding and combination plowing provide a good seed bed for planting and root growth. Disking provides temporary erosion and water runoff benefits. Similarly the gap produced by ripping will create a small infiltration point for water. Ripping alone will reduce the amount of soil exposed to erosion and water runoff events. Bedding may also provide a small water infiltration area.

The drawback of current disking methods is that by raising, uplifting and turning over the soil large areas of loosened soil are exposed to wind and rain, thereby increasing the erosion and runoff potential. Similarly, bedding has a tendency to divert water runoff from its natural flow pattern, concentrating water and sediments to a few specific points on the site. Bedding can also increase the likelihood of channel erosion.

The fourth component of intense silvicultural regeneration operations is fertilization. A great deal of research has investigated the nutrient needs of crop trees throughout their growth cycle. Fertilizer is usually applied at planting and at mid-rotation. The per acre levels of fertilizer applied in forestry applications are generally much higher than those applied in traditional agriculture. Significant concentrations of fertilizer are generally applied to a forestry site on a “one shot” broadcast basis during the first year or two in a new stand.

The forestry benefits of applying high dose fertilizer treatments are significant growth of the new stand and improvement in the health of the new crop trees. However, the application of high concentrations of fertilizer at new stands poses significant water quality issues. Any significant rain event, particularly where the site is not provided with adequate filtering and infiltration structures, will cause fertilizer runoff to be carried to down slope waterways.

Forest sites are classified as non-point sources of pollution since clear-cut hill slopes flow into channels and watersheds. Efforts are being made in the forestry industry to reduce pollution from non-point sources to improve water quality. As part of these efforts the industry has adopted certain Best Management Practices to reduce erosion on cutover sites.

The primary approach in these practices is to create a Streamside Management Zone down slope along drainage systems. A SMZ is created by leaving standing timber and undergrowth in a border that runs parallel to a drainage system on both sides of the drain. All logging, site preparation, and fires are restricted in this zone. The SMZ serves as a natural filter and catchment zone which is intended to stop the sediment that will run off the upsiope of a logged area.

According to present methods, the SMZ is the main barrier between a drainage system and the erosion and runoff from the forestry hill slope. Should the sediment loads and/or runoff velocity and volume exceed the filtering capacity of the SMZ, the excess will run into the drainage system.

The upslope activities employed on a site will depend on the steepness and erosion potential of a site. According to Best Management Practices, all mechanical work on the upslope of a hill should be performed along the contour of the slope. Intensive mechanical site preparation, particularly on a steep and erodeable site, is discouraged. Fire is generally prescribed on these sites. Similarly, hand planting at these sites in encouraged. Water bars may be installed on fire lines and dirt roads to reduce run off. Finally, where mechanical site preparation techniques are employed, ephemeral areas are designated to be left untouched. While these ephemeral areas are important for improving erosion and water quality issues, their presence reduces the useable area of a site for the production of tree crops and constrains movement during planting and post planting activities.

The demands of modem forestry require that cut-over timberland sites be managed at intense levels so as to produce maximum growth in the shortest period of time. As discussed above, many of these intense practices can have a negative impact on erosion, water quality and greenhouse gas emissions. Because the crop trees will not be harvested for twenty to thirty years and many of the adverse effects of the intense practices will be naturally alleviated, there is little incentive for changing present practices. According to present practices, erosion and runoff preventive measures other than the SMZ may be incorporated into a site after site preparation and planting have occurred. As such, these preventive measures may be considered restorative, requiring the additional expenditure of manpower and material. Because of the added costs, only the most severe problems will be receive treatment. Accordingly, there is a need for advanced silvicultural methods that maximize the production capacity of forestry sites while reducing the adverse environmental consequences of present silvicultural techniques.

Present site preparation silvicultural methods have a negative impact on the storage and emissions of greenhouse gases and global warming. Burning of biomass on forest and farmland is recognized as one of the main sources of emissions of greenhouse gases in the world. The elimination of vegetation results in lower carbon storage in the plants and soils. Also, the exposure of bare soil results in the release of additional greenhouse gases through various chemical and biological processes. The use of large quantities of nitrogen fertilizers results in the volatizing of the nitrogen into the atmosphere.

### SUMMARY OF THE INVENTION

Our new method represents an integrated approach to silvicultural management practice designed to reduce or eliminate the adverse environmental impact of present intensive forestry operations. A further object of our invention is to provide a new water management practice.

The key feature of our method is reducing the environmental insult to the site while preserving and augmenting natural erosion barriers. This is achieved by 1) providing “tillage” to narrowly defined bands, referred to hereinafter as infiltration zones; 2) preserving the vegetative integrity of the site while providing access corridors; 3) providing debris filter zones, interposed between successive pairs of infiltration zones and access corridors; and 4) reducing the environmental loading of chemical herbicides and fertilizers. According to the present invention, planting and cultivation of the crop trees is constrained to the infiltration zones.

By limiting planting and cultivation of the crop trees to the infiltration zone, vegetative herbicide use may be reduced from the broadcast “site kill” methods presently employed to narrowly constrained band application along the infiltration zones. Moreover, the “tillage” provided by our invention enables delaying treatment with woody herbicides for two to three years and then allowing selective application only to those areas with woody grow-back. The reduction in the quantity of vegetative and woody herbicides required to effectively treat a forestry site prepared according to the present invention represents a substantial cost savings as well as a substantial reduction in the loading of these herbicides into the environment.

In similar manner, limiting the cultivation of the crop trees to the infiltration zones permits band treatment with chemical fertilizers rather than broadcast application as required by present methods. Since the concentrations of chemical fertilizers utilized in silvicultural applications are greater than those in traditional agricultural applications, the substantially reduced requirements for such fertilizers provides significant cost and environmental advantages over traditional silvicultural operations.

The key to our method is reducing the environmental insult to the forestry site. This aspect is first emphasized in our creation of the infiltration zones. In some intensive silvicultural practices, the site is subjected to gross tillage wherein the hardpan and compaction layers are opened and turned over by disking, ripping, or a combination thereof. According to the practice of our method, tillage is confined to the narrowly defined infiltration zones. Similarly, within these narrowly defined zones, the configuration of our star shaped cultivating disk gang provides deep penetrating tillage while reducing the lifting and turning of the soil such that the tilled soil remains roughly at ground level, again reducing the insult to the site and adverse erosion exposure. Moreover, the unique design of our star shaped disk enables the disk to sever the woody plant root structure within the infiltration zone, providing the cultivated crop trees a non-competitive environment in which to become established. This particular aspect also permits a two to three year delay in the application of the woody herbicide treatments that are employed immediately with current practices.

This infiltration zone also serves as a water catchment area. Rain water runoff is caught in these areas. Much of the runoff remains upslope, thus reducing water flow into the streamside management zone (SMZ). This infiltration zone also serves as a water storage reservoir. Water is stored in this area to be used later by the crop trees.

In areas where a hardpan exists, our star shaped disk tillage may be augmented by the use of a ripper. In these instances, we confine the use of the ripper within the lateral boundaries of the infiltration zone. We follow the ripper with our star shaped disks to close the gap created by the ripper and to minimize the vertical and lateral displacement of the soil bed in the infiltration zone.

Providing unimpeded access to the infiltration zones in our method eliminates the need to use fire and permits the use of band application of herbicides and fertilizers. According to our method, access corridors are provided using a large horizontal blade, such as a bulldozer blade, to clear the logging debris left on the site. Preferably the bulldozer blade will be substantially V shaped along its transverse length so that the debris can be pushed to either side of the advancing blade. The displaced debris is thereby consolidated along the lateral boundaries of the access corridor and infiltration zones, defining debris filter zones. Unlike current practices in which the blade is set to engage the ground beneath the soil surface, we elevate the blade slightly so as to minimize disturbing the soil surface. By maintaining the blade in an elevated position relative to the soil surface, we also preserve the beneficial soil stabilization and runoff protection provided by the vegetative root structure within the access corridors.

As just described above, debris filter zones are created along the lateral boundaries of the access corridor by the displacement of the logging debris from the surface of the access corridors. According to our method we leave the soil within these zones intact along with its existing vegetative cover. By combining the logging debris with the intact soil and vegetative cover we are able to augment the natural filtration mechanisms of the site and improve the efficiency of the system.

By this aspect of our method, primary filtration and runoff protection is provided by the debris filter zones and infiltration zone rather than by the streamside management zone (SMZ), thereby preserving the protective capacity of the SMZ.

Since our method provides access to site, the need to burn is eliminated. Therefore, the debris left on site is allowed to decompose at its natural rate resulting in a slow release of carbon dioxide back into the atmosphere over a period of years. If present practices were followed, the site would be burned, the stored carbon in the debris would be converted into carbon dioxide by the fire and released back into the atmosphere within an hour. Also, the burning would create new additional greenhouse gases and tropospheric ozone. Since our method reduces soil exposure due to the elimination of fire, preservation of vegetation and minimal tillage, the potential for other adverse biological processes that generate additional greenhouse gases is lowered or eliminated. The preservation of the vegetation due to the targeted chemical approach also improves carbon storage in the plants and soils. Banding of fertilizer reduces the amount applied on site thus reducing the amount of nitrogen available for volatization.

### BRIEF DESCRIPTION OF THE DRAWINGS

FIG. 1A depicts a forestry hill slope prepared with a dual gang tiller according to the present invention;

FIG. 1B depicts a forestry hill slope prepared with a single gang tiller according to the present invention;

FIG. 2A depicts a forestry hill slope in its first year prepared according the cut and leave method in the prior art;

FIG. 2B depicts a forestry hill slope in its first year prepared according to current intensive silvicultural methods;

FIG. 2C depicts a forestry hill slope in its first year prepared according to the present invention;

FIG. 3A depicts a forestry hill slope in its second year prepared according to the cut and leave method in the prior art;

FIG. 3B depicts a forestry hill slope in its second year prepared according to current intensive silvicultural methods;

FIG. 3C depicts a forestry hill slope in its second year prepared according to the present invention;

FIG. 4A depicts a forestry hill slope in its third year prepared according to the cut and leave method in the prior art;

FIG. 4B depicts a forestry hill slope in its third year prepared according to current intensive silvicultural methods;

FIG. 4C depicts a forestry hill slope in its third year prepared according to the present invention;

FIG. 5A depicts a forestry hill slope in its fourth year prepared according to the cut and leave method in the prior art;

FIG. 5B depicts a forestry hill slope in its fourth year prepared according to current intensive silvicultural methods;

FIG. 5C depicts a forestry hill slope in its fourth year prepared according to the present invention;

FIG. 6 is a rear perspective view of a star shaped tillage gang of the present invention;

FIG. 7 is a rear perspective view of a star shaped tillage gang in its elevated position;

FIG. 8 is a side view of a star shaped tiller gang and ripper according to the present invention;

FIG. 9 is a side view of an alternative embodiment of a star shaped tiller blade having blunt edged points;

FIG. 10 is a side view of an embodiment of a star shaped tiller blade having deep penetrating star points;

FIG. 11 is a bottom plan view of a tiller gang and disk sweep.

FIG. 12 is a partial view of a preferred embodiment of the support beam, gang arms, and actuators;

FIG. 13 is a side view of a preferred embodiment of the tiller; and

FIG. 14 is a partial side view of a tiller gang showing the disk sweep.

### DESCRIPTION OF THE PREFERRED EMBODIMENT

Current intensive silvicultural regeneration practices destroy most of the natural erosion and water runoff control ecosystems found on a hill slope. Our new method of erosion and water runoff control for cutover timberland sites preserves two of these natural systems and restores one natural system that is lost when current intensive regeneration practices are used. The immediate economic and silvicultural benefits provided by practicing our invention will introduce an added incentive to reducing the environmental impact of forestry operations.

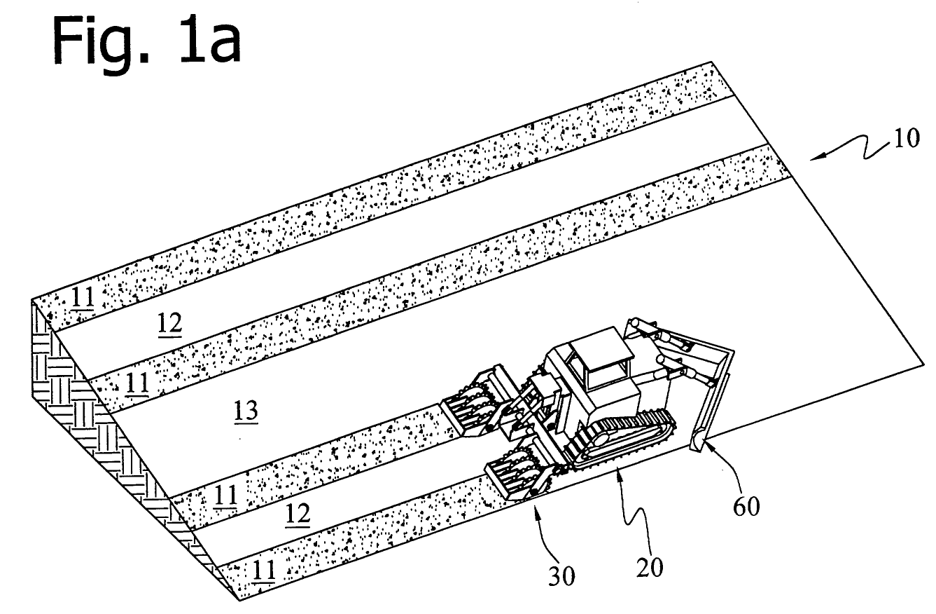

Many areas on a hill slope are compacted due to logging activities, site preparation equipment traffic, or inherent soil characteristics. These areas do not allow for infiltration of rain water. Also, areas that have lost their infiltration capacity due to fire treatments promote excess water runoff. This infiltration ecosystem can be restored by tilling a plurality of parallel infiltration zones 11 into the ground along the contour line of a hill slope, as may be seen by reference to FIGS. 1A and 1B. Tillage within infiltration zone 11 should provide deep penetration and loosening of the soil with minimal lifting or turning over of the soil at the surface. According to our invention, the tilled soil within infiltration zone 11 will only rise one to four inches above ground level, which will settle back after several rains. By minimizing lifting and turning of the surface soil in infiltration zone 11, we avoid diversion of the natural water flow patterns common with raised bed methods. Instead, our tilling permits and encourages the natural surface water flow across infiltration zone 11, which results in better water infiltration into the hill slope across the width and length of infiltration zone 11. In addition, the rougher surface of infiltration zone 11 intercepts and encourages depositing of suspended sediment from the flowing water. Moreover, our unique tillage technique within infiltration zone 11 reduces the exposure of large quantities of disrupted soil to wind and water erosion.

The depth and width of infiltration zone 11 will vary depending upon the crop tree to be cultivated on the site and the site's soil characteristics. An infiltration zone 11 prepared for various species of pine will typically be made approximately thirty two inches wide and roughly about fourteen inches deep. Site specific soil conditions will influence the depth selection. Similarly, slope and soil conditions may influence the width of the infiltration zone 11. As such, the dimensions provided herein are merely exemplary and are not intended to limit the scope of the invention claimed.

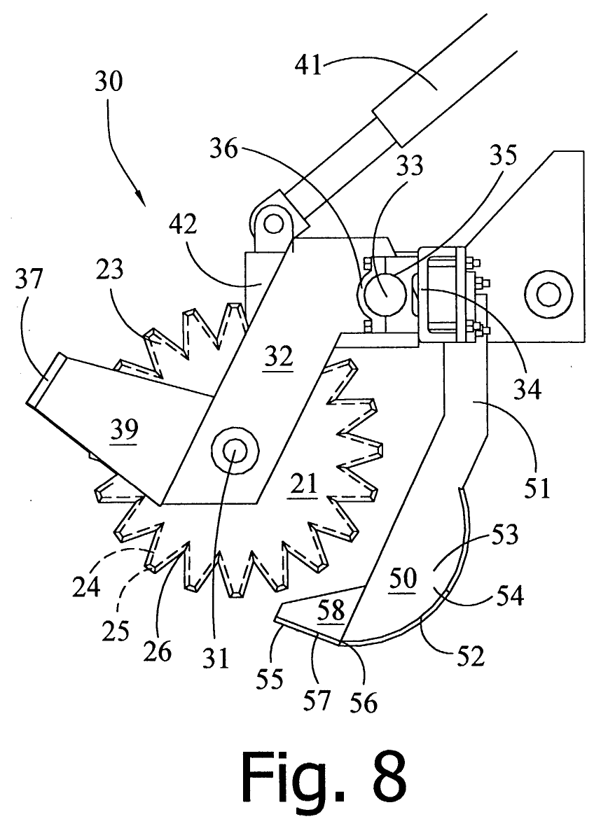

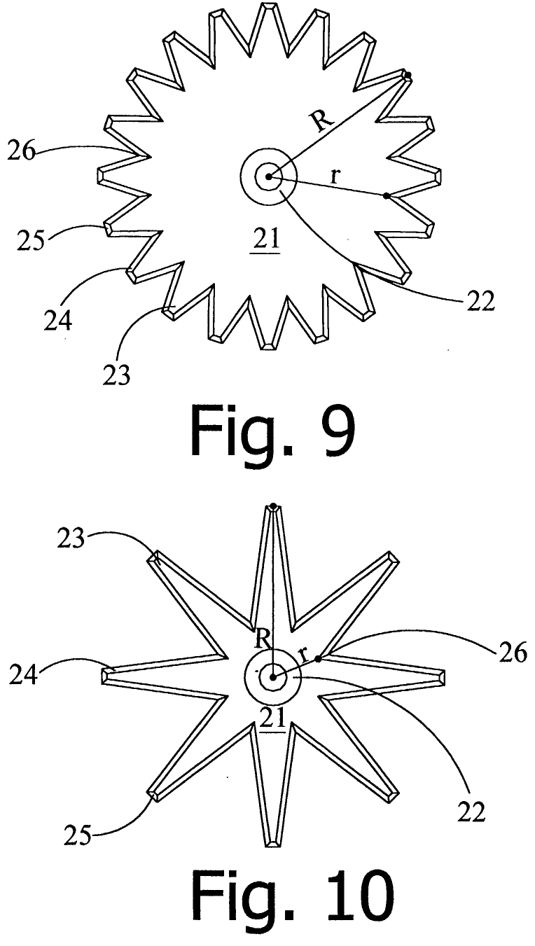

As shown in FIGS. 1A and 1B, tillage of infiltration zone 11 is provided by urging at least one gang 30 of rotating star shaped disks 21 in penetrating engagement with the ground. The gang 30 is drawn across the contour of a slope by a prime mover 20, which may be a tractor, but more preferably a bulldozer. As best seen in reference to FIGS. 9 and 10, each disk 21 or blade is comprised of a substantially flat circular disk defining a primary blade radius r. Blade 21 is provided with a central hub portion 22 having a radius substantially smaller than primary blade radius r. A plurality of star points 23 radially emanate from the circumference of the flat circular disk. Each star point 23 comprises at least one sharpened cutting edge 24 extending from a tip 25 of the star point 23 to a substantially V-shaped junction 26 defined by the intersection of adjacent star points 23. The tips 25 define a secondary disk radius R. In our preferred embodiment, each star point 23 has two sharpened cutting edges 24, one on the leading edge and one on the trailing edge of star point 23, relative the rotation of blade 21 across the ground. More preferably, sharpened cutting edges 24 extend to and include sharpening of V-junction 26.

A disk 21 according to the present invention can have between about eight to twenty-four star points 23, depending upon soil conditions. In the conditions we frequently encounter our preferred configuration has between about fifteen to eighteen star points 23. In the rugged applications for which the device is intended and to achieve the required penetration depths, the primary radius r, of blade 21 should be between about 24 inches to 62 inches and the secondary blade radius R will be between about 6 to 16 inches greater than that of the primary blade radius r.

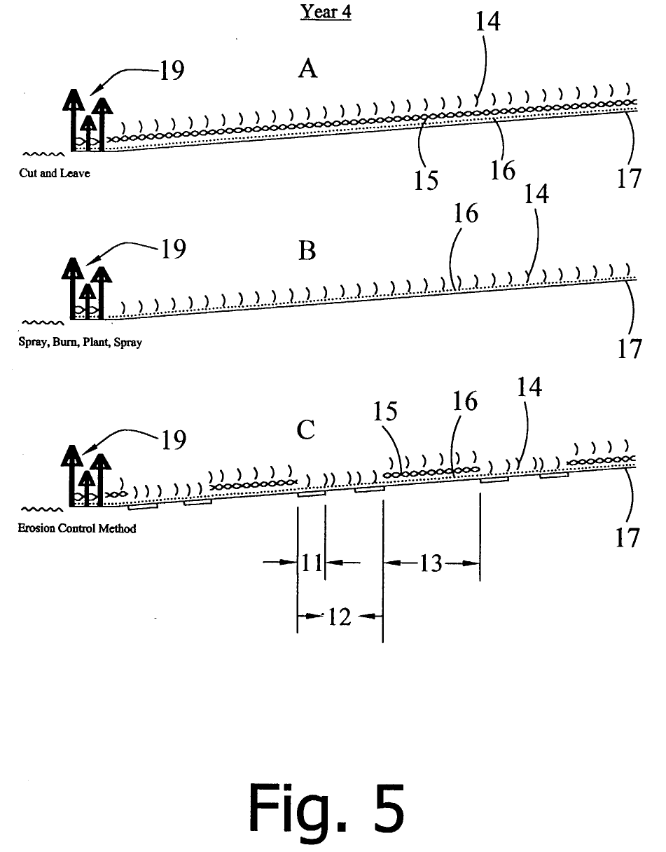

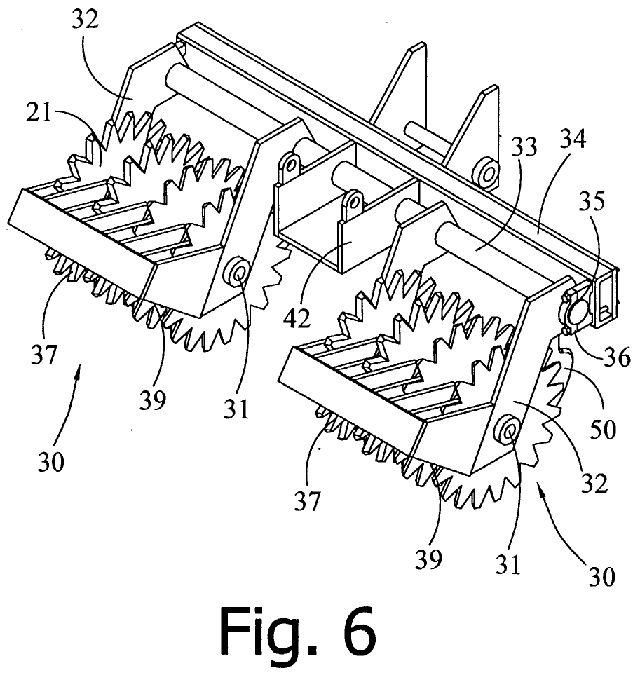

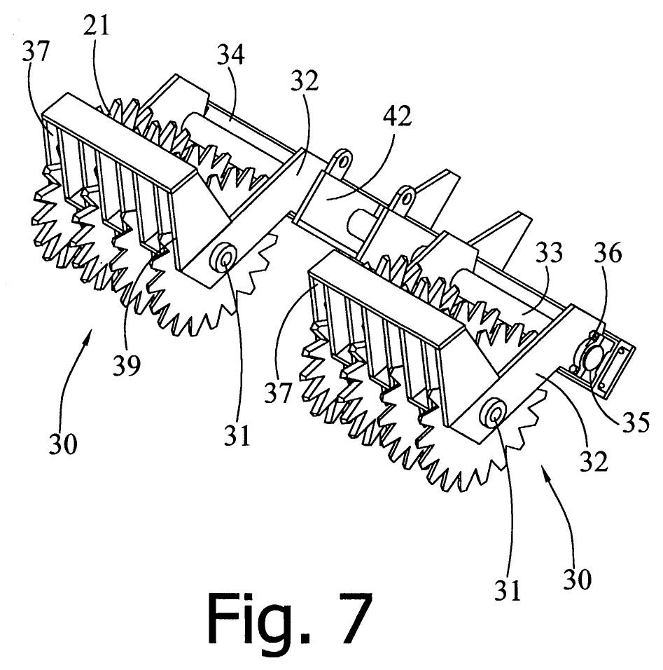

As shown in FIGS. 1A, 1B, and 6-8, disks 21 are mounted in a gang 30 for axial rotation about a disk shaft 31 disposed between a plurality of gang arms 32. Since it is an object of our invention to minimize the vertical lifting and lateral displacement of the soil in the infiltration zone, disks 21 are arranged in parallel to engage the ground vertically. Similarly, disks 21 are arranged to parallel their longitudinal displacement across the ground when drawn by prime mover 20. Disks 21 may be configured for rotation in unison with one another or may be independently rotatable about disk shaft 31.

In one embodiment of our tiller, gang arms 32 are attached at a first end for pivotal displacement about a gang shaft 33. Gang shaft 33 is operatively coupled to a tiller support beam 34 by means such as bearings 35 and bearing retainers 36. A frame shaft actuator 41 operatively couples a frame shaft articulating arm 42 with a frame shaft receiver (not shown) attached to prime mover 20. Displacement of fame shaft articulating arm 42 by movement of actuator 41 translates the linear movement of actuator 41 to rotational movement of frame shaft 34. Extension of actuator 41 lowers gang arms 32 and urges disks 21 into penetrating engagement with the ground. Disk 21 penetration depth may be controlled by selectively positioning gang arms 32 with actuator 41. Retraction of actuator 41 raises gang arms 32 thereby withdrawing or partially withdrawing disks 21 from ground engagement.

Dispersion of displaced soil is also avoided by including gang arm extensions 39, which extend rearward of gang arms 32 to a point beyond secondary disk radius R. Laterally displaced soil will contact the face of gang arm extensions 39 which contain the errant soil within the infiltration zone 11.

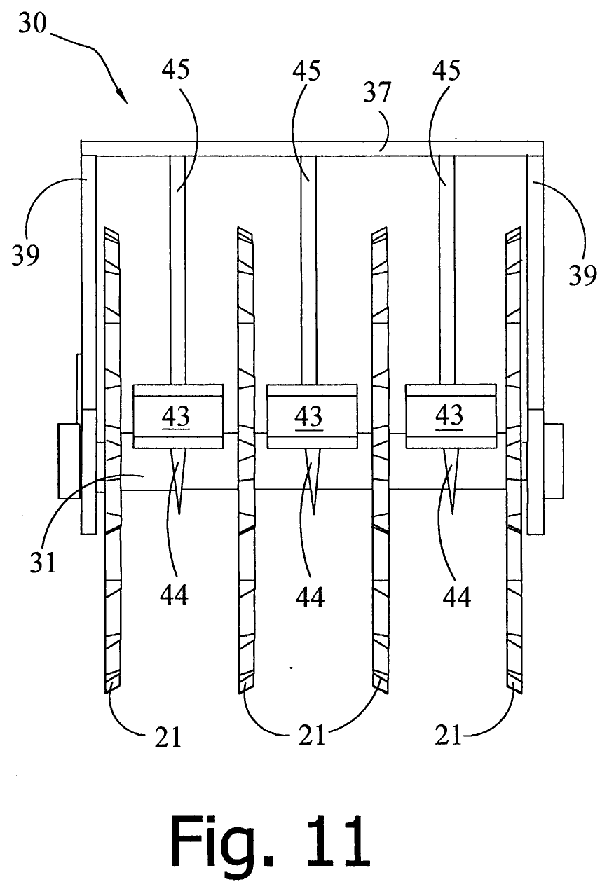

Lateral spacing between gang arms 32 is maintained by a reinforcing plate 37 affixed to the ends of gang arm extensions 39 in a trailing position behind disks 21. Separation between disks 21 on disk shaft 31 is maintained by a spacer sleeve, set pins, welds, or any attachment means known in the art. As may be best seen in reference to FIG. 11, fouling of disks 21 by adherent soil or vegetative debris may be avoided by providing a disk sweep 43 disposed between adjacent star shaped disks 21.

Each disk sweep 43 is positioned forward of reinforcing plate 37 at a point subjacent disk shaft 31. Each disk sweep 43 is roughly L-shaped, with the inside angle of the L greater than 90 degrees and less than 180 degrees. Disk sweep 43 is held in position by disk sweep support bars 45. Support bars 45 not only hold the disk sweeps 43 in place, but it also assists in removing dirt and debris from between the star shaped disks 21. A first disk sweep support bar 45 extends forwardly from reinforcing plate 37. A second disk sweep support bar 45 extends rearwardly from a disk sweep support rod 46, where disk sweep support rod 46 extends laterally between adjacent gang arms forward of the outer circumference of disk 21. Disk sweep 43 is attached at the junction between first and second support bars 45. As disks 21 rotate about starwheel shaft 31, debris or dirt adhering to disks 21 contact sweep 43 and is returned to the infiltration zone surface. Disk sweep support bars 45 also prevent accumulation of adherent soil and debris between disks 21. For additional tillage of adherent dirt, sweep 43 may further comprise at least one sweep blade 44 vertically disposed subjacent disk shaft 31. The adherent dirt will be urged against blade 44 to be split and returned to the surface of infiltration zone 11.

When tilling a site, particularly a site which has had a timber stand harvested or removed, tiller gang 30 will frequently encounter submerged roots, stumps, or boulders. While the unique design of the star shaped disks 21 is intended to sever submerged roots of the woody scrub within infiltration zone 11, larger roots, stumps, and boulders in its path may damage disks 21. For these conditions, each tiller gang 30 is provided with at least one ripper 50.

Ripper 50 is mounted at its first end or shank 51 to support beam 34. Ripper 50 extends rearward and downwardly from shank 51, and terminates at a point beneath the arch circumscribed by disks 21 as they rotatingly engage the ground within infiltration zone 11. A sharpened blade portion 52 is defined along a forward edge 53 opposite shank 51 to facilitate penetration of ripper 50 through the soil. Sharpened blade portion 52 may also sever larger roots embedded within infiltration zone 11. For instances where the submerged roots, stumps or boulders can not be severed or moved by ripper 50, sharpened blade portion 52 also comprises an arcuate portion 54 which permits ripper 50 to ride over the obstruction.

As mentioned previously, actuator 41 urges support frame shaft 33 downward, assisting ripper 50 into penetrating contact with the ground. Actuator 41 may also be set to bias support beam 34 and ripper 50 at a predetermined contact force with the ground. When ripper 50 encounters an obstruction which it is unable to sever, the force will be communicated through support beam 34 and overcome the biasing force of actuator 41. Once the biasing force has been exceeded, the forces against ripper 50 will cause support beam 34 to pivotally displace permitting arcuate portion 54 will ride over the obstruction. Once the obstruction is cleared by ripper 50, actuator 41 will again bias ripper 50 into penetrating contact with the ground.

In order to improve deep tillage within infiltration zone 11, particularly in sites with a hardpan layer, ripper 50 may also be provided with a ripper sweep 55 attached to its second end. Ripper sweep 55 is a substantially V-shaped wedge with its apex 56 attached to ripper 50 at the lower tip of arcuate portion 54. The rearward extending wings of ripper sweep 55 have sharpened forward edges 57 to assist in breaking the hardpan and severing smaller submerged root structures. A reinforcing member 58 extends from the aft edge of ripper 50 and is attaches to the top surface of ripper sweep 55 to maintain ripper sweep 55 substantially horizontal relative to the ground. Ripper sweep 55 may also be required in order to till a site with a significant compaction layer. In this case, ripper sweep 55 and ripper 50 will assist actuator 41 with urging support beam and ultimately gang 30 into penetrating engagement with the infiltration zone.

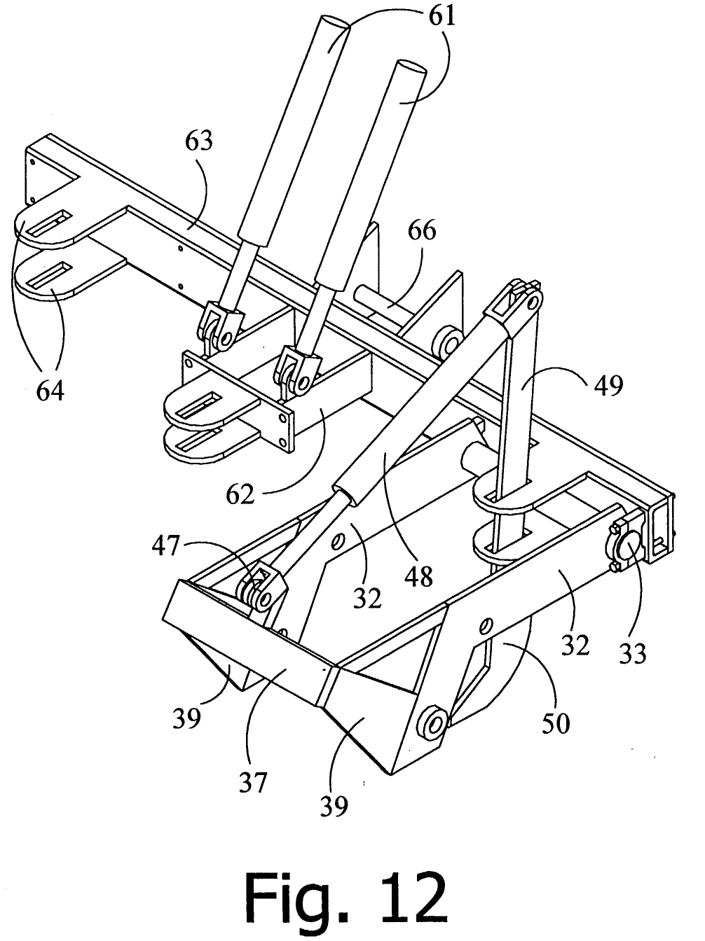

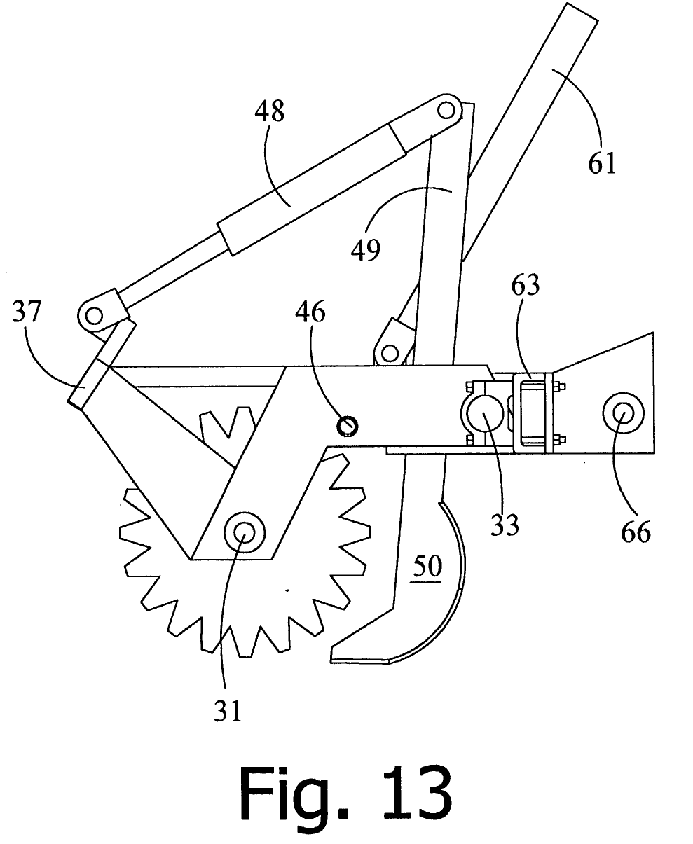

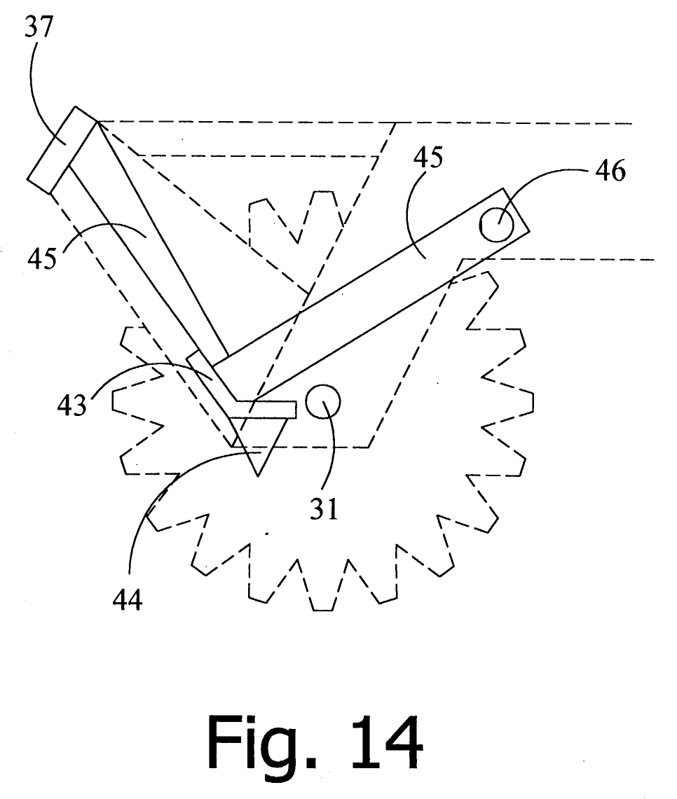

In a preferred embodiment of our tiller, depicted in FIGS. 12-14, the tiller gangs 30 are mounted to a support beam 63 to permit independent articulation as they are drawn across the ground by prime mover 20. As shown in FIG. 11, support beam 63 is comprised of a substantially rectangular beam with a plurality of ripper mounts 64 and support beam articulating arm 62. Tiller support beam 63 attaches via a support beam shaft 66 to a support beam shaft receiver (not shown) attached to the prime mover 20. A support beam actuator 61 operatively couples support beam articulating arm 62 with the support beam shaft receiver. Displacement of the articulating arm 62 by movement of actuator 61 provides pivotal movement of support beam 63 about support beam shaft 66. Support beam actuator 61 permits raising and lowering of gangs 30 in unison with support beam 63.

As with our other embodiment, gang arms 32 are attached at a first end for pivotal displacement about gang shaft 33. However, in this embodiment, each gang 30 is provided its own gang shaft 33. Each gang shaft 33 is operatively coupled to support beam 63 by conventional means such as bearings and bearing retainers affixed to support beam 63. Each gang 30 is independently controlled by a gang arm actuator 48 operatively coupled between a reinforcing plate extension 47 and a gang arm actuator bar 49. Gang arm actuator bar 49 can be an independent bar secured in the ripper mount 64, or otherwise extending from and affixed to support beam 63. Similarly, gang arm actuator bar 49 may be formed by a vertical extension of ripper shank 51. Displacement of gang arm actuator 38 causes pivotal displacement of the gang 30 about gang shaft 33.

In this embodiment, each actuator 38 can independently position gang arms 32 and urges disks 21 into penetrating engagement with the ground. Disks 21 penetrative depth may be controlled by selectively positioning starwheel arms 32 with actuator 38 and actuator 61. Retraction of actuators 38 and 61 raise the starwheel arms 32, thereby withdrawing or partially withdrawing disks 21 from ground engagement. The arrangement of the above-mentioned components allows for the rapid and versatile transformation of the tiller to a one-, two- or three-row tiller.

In our preferred embodiment, a pair of tiller gangs 30 are disposed on support beam 63. Each gang 30 is mounted on the support beam 63 such that it is in a trailing position behind the path of the ground engaging wheels or tracks of prime mover 20. By this arrangement, we can further limit the insult to the site's surface. Where greater separation between adjacent infiltration zones 11 is required or desired, a single gang 30 may alternatively be employed. Where less separation is desired more than two gangs may be employed.

Our best success has been found when two pairs of disks 21 are provided in a gang 30 mounted on starwheel shaft 31 and each pair of disks 21 is arranged so that their cutting edges 24 urge the tilled soil inwardly towards the centerline of gang 30. As gang 30 is drawn across the ground, the shape, alignment and arrangement of disks 21 provide the infiltration zone a tilled bed of soil with a substantially rectangular cross section. The depth and degree of tillage within the infiltration zone is controlled by the number of the star points 23 provided on disks 21, the length of primary radius r, the length of secondary radius R, and the depth to which disks 21 are urged into penetrating engagement with the ground.

In current intensive silvicultural site preparation techniques, logging and residual surface debris are removed by fire or mechanical means for access to the site. As a result of these practices, important ground cover and barrier water filter ecosystems are destroyed. According to present practices, restoration of this ecosystem is accomplished by deploying off-site material such as mulch and erosion fences. These practices become extremely cost prohibitive for the large scale applications typically required in forestry. We have found that preservation of the natural erosion and filtration ecosystems is a far more effective practice.

According to our invention, we provide the prime mover 20 with an articulating blade 60, to provide an obstruction free access corridor 12. The tiller gang 30 works in cooperation with articulating blade 60 to provide at least one infiltration zone 11 in access corridor 12, as may be seen in reference to FIGS. 1A and 1B. As the prime mover 20 draws tiller gang 30 over the site, blade 60 will be pushing surface debris 15 to the left and or right of access corridor 12. Preferably blade 60 is V-shaped across its transverse span to facilitate equal dispersion of debris to the left and right of access corridors 12 and infiltration zones 11. Rather than engaging blade 60 below the ground surface 17, as is the practice in the art, we elevate blade 60 slightly so as to avoid disturbing the duff or humus surface layer 16 within access corridor 12, thereby preserving the natural erosion and filtration ecosystems.

In similar fashion we preserve and augment the natural erosion and filtration ecosystems bordering our infiltration zones 11 and access corridors 12. The use of fire is eliminated. As previously described, blade 60 works to clear the surface debris 15 to the left and right as prime mover 20 traverses the hill contour. We deposit the debris 15 over undisturbed ground bordering the access corridor 12 with its natural vegetative cover intact. By depositing the surface debris 15 in these areas, which we call the debris filter zone 13, we augment the natural protective vegetative cover. When prime mover 20 reaches the end of a row it will turn around displace up or down slope by a predetermined offset distance from the preceding path in order to traverse and clear subsequent infiltration zones 11 and access corridors 12. During the subsequent pass, debris will again be displaced to the left and right of blade 60 over the relatively undisturbed ground having its natural vegetative cover intact. Debris from the subsequent pass will accumulate in the debris filter zone 13 defined during the preceding pass.

The width of debris filter zone 13 will vary depending on factors such as the degree of slope, the quantity of residual debris 15, the amount of vegetative cover on site, and the site's soil characteristics. In general, a steeper slope, limited residual debris, limited vegetative cover, and an erosion prone soil composition will all favor a wider debris filter zone. With these considerations in mind, a debris filter zone according to our invention will generally be on the order of about ten feet in width.

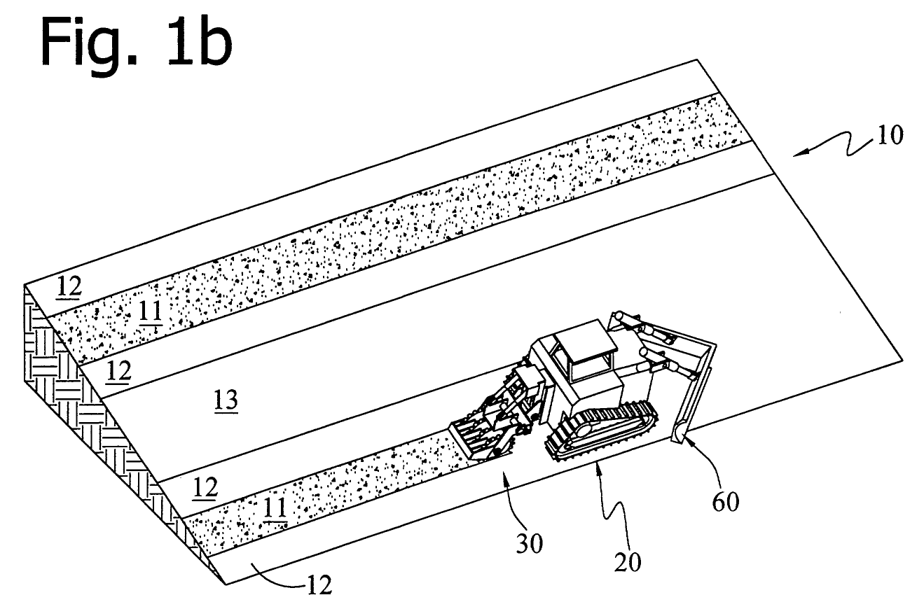

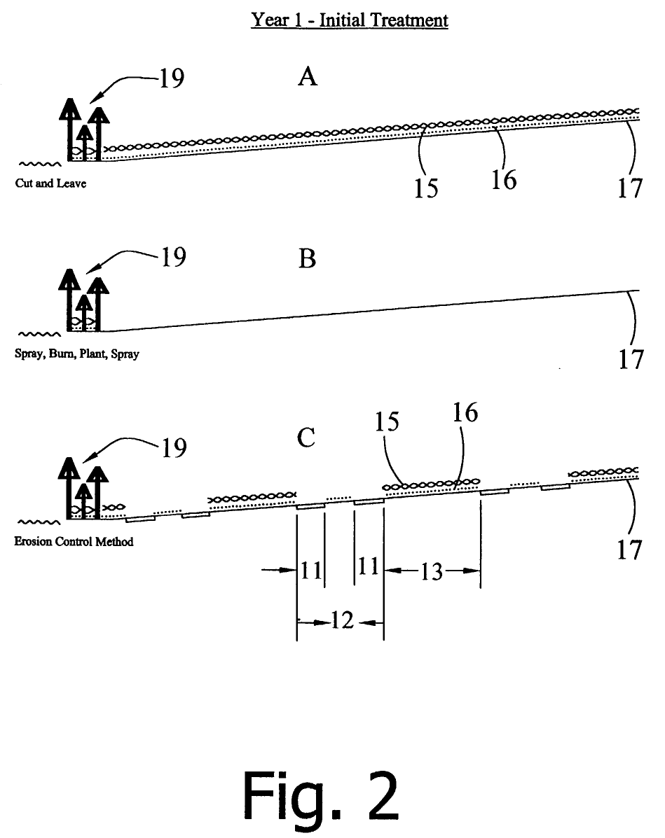

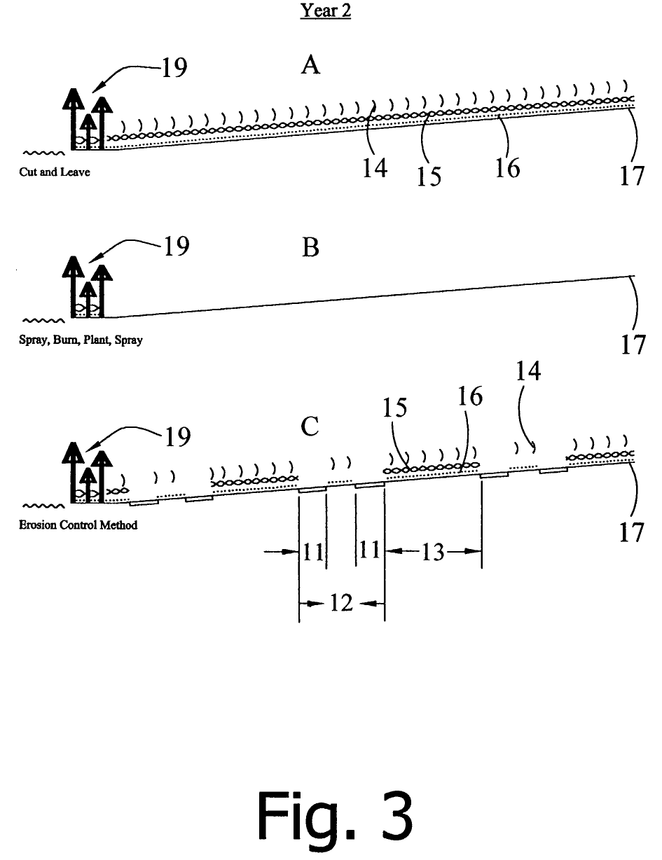

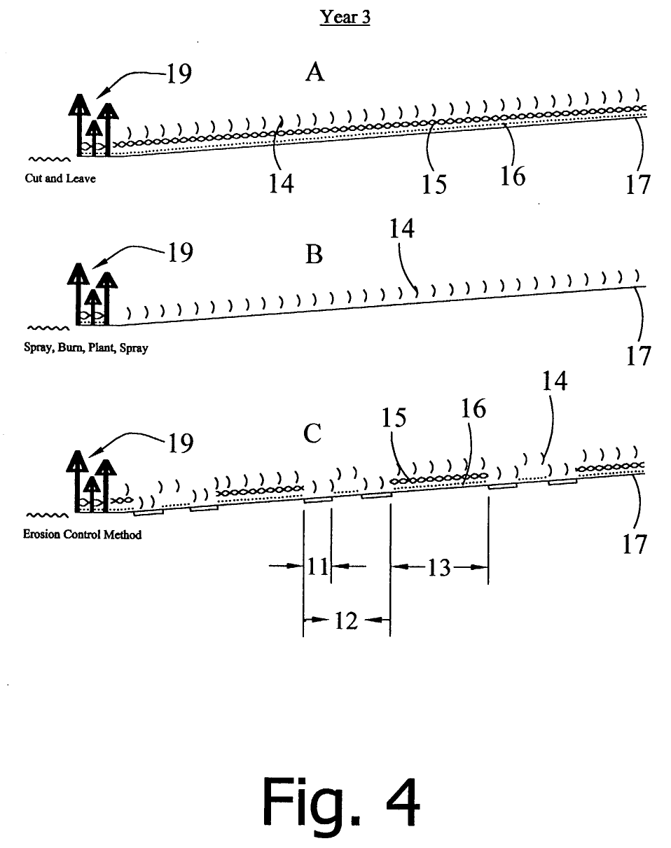

A comparison of our method with existing methods is shown in FIGS. 2-5. As shown in FIGS. 2A-5A, a chemically untreated timber site will start to naturally grow back 14 with weeds, grasses and woody plants shortly after it has been cut. This grow back 14 is an essential component of the vegetative cover ecosystem. Yet this plant grow back 14 is precisely what current intensive silvicultural regenerative practices, depicted in FIGS. 2B-5B, seek to eliminate with herbicides, clearing, fire and gross tillage. Current practice calls for spraying a woody control herbicide to the entire site after the site is clear cut. This is usually followed by a fire. These steps are completed before planting the crop trees. In the spring following planting, an herbaceous weed herbicide is sprayed on the entire site. These practices are intended to eliminate all competitive growth in order for the young crop trees to thrive. However, these same practices destroy the erosion protective contributions the competitive plants provide to the site.

We prefer a targeted approach as depicted in FIGS. 2C-5C. According to our invention, the star shaped disk gang 30 severs the woody and scrub roots within infiltration zones 11 into several sections. This process eliminates most of the woody competition within infiltration zones 11 for several years, leaving the crop trees free to grow without woody competition. Herbaceous grow back is only competitive where it occurs in close proximity with the crop trees. According to our method, we eliminate herbaceous competition by band application of a herbaceous weed herbicide within infiltration zones 11. As with traditional methods, this is applied in the spring following planting. However, by targeting the herbicide treatment to infiltration zones 11, we are able to successfully treat a site with smaller quantities of herbicide. Moreover, by preserving the non-competitive herbaceous and woody vegetation within access corridors 12 and debris filter zones 13, we are able to harness the natural erosion and filtration capacity provided by these ecosystems. Tillage according to our methods reduce the demands placed on the streamside management zone 19, permitting the SMZ 19 to augment rather than serving as the primary runoff protective measure for the silvicultural site.

By our method, we are able to preserve the vegetative ecosystems while achieving the objectives of intense silvicultural regeneration, competition free crop tree growth during its early years. Similarly, by planting the crop trees in infiltration zone 11, where compaction has been eliminated, the crop trees are provided a favorable rooting environment. In addition, more water resources are directed to the crop trees by the increased infiltration provided by our tiller. Moreover, by confining planting to infiltration zones 11, more precise and orderly planting can be achieved. In combination with the access corridors 12 this imparts significant efficiency to various post planting activities, such as spraying, fertilization, and survival surveys since the number and location of crop trees can be readily determined.

Although we have described various embodiments of our invention in detail above, those skilled in the art will readily appreciate that many modifications are possible without materially departing from the novel teachings and advantages of our invention. Accordingly, all such modifications are intended to be included within the scope of our invention as defined in the appended claims.

What is claimed is:

1. A blade for a silvicultural tillage apparatus comprising:
a substantially flat circular disk, defining a primary blade radius;
a hub coaxial with said substantially flat circular disk, said hub having a radius substantially smaller than said primary blade radius; and
a plurality of star points spaced apart and radially emanating from the circumference of said substantially flat circular disk; each said star point comprising a tip, a leading edge, and a trailing edge, and said tips defining a secondary blade radius.

2. The blade of claim 1 wherein each said star point further comprises a sharpened leading edge cutting surface.

3. The blade of claim 2 wherein each said star point further comprises a sharpened trailing edge cutting surface.

4. The blade of claim 1 wherein the leading edge of each said star point intersects with the trailing edge of a successive star point and defining a substantially V-shaped notch between each said star point and a successive star point and said substantially V-shaped notch is defined at said primary blade radius.

5. The blade of claim 4 wherein each said star point further comprises at least one leading edge cutting surface.

6. The blade of claim 5 wherein each said star point further comprises at least one trailing edge cutting surface.

7. The blade of claim 4, wherein and each said V-shaped notch comprises at least one sharpened cutting surface.

8. The blade of claim 4 wherein said star points have a blunt tip.

9. The blade of claim 8 wherein said blunt tip has at least one sharpened cutting surface.

10. The blade of claim 1 wherein said primary blade radius is between about 24 inches to 62 inches.

11. The blade of claim 10 wherein said secondary blade radius is between about 6 inches to 16 inches greater than said primary blade radius.

12. A selectively positionable silvicultural tillage gang comprising:
a plurality of gang arms, each said gang arm having a forward end pivotally attached about an axially rotatable transverse gang shaft;
said transverse gang shaft rotatably attached to a transverse frame beam;
a disk shaft, disposed between adjacent pairs of said gang arms at an aft end of each said gang arm, receives a plurality of spaced apart silvicultural tillage blades for coaxial rotation about said disk shaft,
said silvicultural tillage blades aligned parallel to each other for vertical penetrating engagement with a soil surface, said silvicultural tillage blades further aligned for penetrating engagement with said soil surface parallel to a longitudinal path traversed by said silvicultural tillage gang.

13. The silvicultural tillage gang of claim 12 further comprising; a plurality of rearwardly extending gang arm extension, said gang arm extensions protruding from said gang arms to a point beyond an aft end of each said silvicultural tillage blade.

14. The silvicultural tillage gang of claim 13 further comprising a reinforcing plate affixed to and extending between an aft end of each said gang arm extension.

15. The silvicultural tillage gang of claim 14 further comprising at least one blade sweep positioned between opposed faces of a pair of adjacent silvicultural tillage blades and a forward end of said blade sweep disposed subjacent said gang shaft.

16. The silvicultural tillage gang of claim 15 further comprising at least one vertical sweep blade extending from a forward end of said blade sweep.

17. The silvicultural tillage gang of claim 12 further comprising a ripper, said ripper comprising: a shank attached to said transverse support beam forward of said silvicultural tillage disks; and
a ripper arm extending rearward and downwardly from said shank, said ripper arm having a sharpened arcuate forward edge.

18. The silvicultural tillage gang of claim 17 further comprising a ripper sweep attached to said ripper arm distal said shank; said ripper sweep comprising a substantially V-shaped wedge with an apex of said wedge attached to a rear edge of said ripper arm, and rearwardly extending wings of said wedge having sharpened forward edges.

19. A silvicultural tillage apparatus comprising, in combination, p1 a self propelled prime moving vehicle;
an articulating blade extending from a forward end of said self propelled prime moving vehicle, means on said self propelled prime moving vehicle for selectively positioning a lower edge of said blade in close proximity to a soil surface as said self propelled prime moving vehicle traverses said soil surface,
a suppport beam operatively attached to and extending from a rear end of said self propelled prime moving vehicle and attachment means for securing at least one transverse shaft to said support beam, said attachment means permitting axial rotation of said transverse shaft; and
at least one silvicultural tillage gang operatively attached to said transverse shaft, said silvicultural tillage gang comprising:
a plurality of gang arms, each said gang arm having a forward end for pivotal attachment to said transverse shaft,
a disk shaft, extends between adjacent pairs of said gang arms at a rearward end thereof, said disk shaft receiving a plurality star shaped silvicultural tillage blades, spaced apart, for coaxial rotation about said disk shaft,
said silvicultural tillage blades aligned parallel to each other for vertical penetrating engagement with a soil surface, said silvicultural tillage blades further aligned for penetrating engagement with said soil surface parallel to a longitudinal path traversed by said self propelled prime moving vehicle.

20. The silvicultural tillage apparatus of claim 19 further comprising; a plurality of rearwardly extending gang arm extensions, said gang arm extensions protruding from said gang arms to a point beyond an aft end of each said silvicultural tillage blade.

21. The silvicultural tillage apparatus of claim 20 further comprising a reinforcing plate affixed to and extending between an aft end of adjacent pairs of each said gang arm extension.

22. The silvicultural tillage apparatus of claim 21 further comprising at least one blade sweep positioned between opposed faces of a pair of adjacent silvicultural tillage blades and a forward end of said blade sweep disposed subjacent said disk shaft.

23. The silvicultural tillage apparatus of claim 22 further comprising at least one vertical sweep blade extending from a forward end of said blade sweep.

24. The silvicultural tillage apparatus of claim 19 further comprising a ripper, said ripper comprising: a shank attached to said support beam forward of said silvicultural tillage disks; and
a ripper arm extending rearward and downwardly from said shank, said ripper arm having a sharpened arcuate forward edge.

25. The silvicultural tillage apparatus of claim 24 further comprising a ripper sweep attached to said ripper arm distal said shank; said ripper sweep comprising a substantially V-shaped wedge with an apex of said wedge attached to a rear edge of said ripper arm, and rearwardly extending wings of said wedge having sharpened forward edges.

26. The silvicultural tillage apparatus of claim 19 further comprising a primary actuator means for selectively positioning said transverse support beam.

27. The silvicultural tillage apparatus of claim 20 further comprising a secondary actuator means for independently positioning said at least one silvicultural tiller gang.

28. A silvicultural method comprising the steps of:
a. providing a silvicultural tillage apparatus comprising, in combination, a self propelled prime moving vehicle; an articulating blade extending from a forward end of said self propelled prime moving vehicle and extending transverse a forward path traversed by said prime moving vehicle; and at least one selectively positionable silvicultural tillage gang operatively attached to and extending from a rear end of said self propelled prime moving vehicle, said silvicultural tillage gang comprising a plurality of spaced apart, star shaped silvicultural tillage blades rotationally disposed in said silvicultural tillage gang,
b. traversing a silvicultural site with said silvicultural tillage apparatus defining, in a single pass, an access corridor, at least one debris filter zone adjacent said access corridor, and at least one infiltration zone within said access corridor.

29. The silvicultural method of claim 28 wherein the step of traversing a silvicultural site further comprises:
a. selectively positioning said articulating blade proximal a ground surface of said silvicultural site, said articulating blade contacting and urging surface debris outwardly to said debris filter zone and clearing said surface debris from said access corridor; and
b. selectively positioning said silvicultural tillage gang to urge said star shaped silvicultural tillage blades into penetrating engagement with said ground surface within said access corridor, said star shaped silvicultural tillage blades defining said at least one infiltration zone within said access corridor.

30. The silvicultural method of claim 28 further comprising the step of:
planting a tree crop within said infiltration zones in the winter months following the step comprising defining said at least one infiltration zone.

31. The silvicultural method of claim 28 further comprising the step of:
applying a tree crop fertilizer by band application within said infiltration zones.

32. The silvicultural method of claim 30 further comprising the step of:
applying an herbaceous herbicide by band application within said infiltration zones in the spring following the step of planting a tree crop.

33. The silvicultural method of claim 31 further comprising the step of:
applying a woody herbicide selectively to those areas with woody grow-back.

34. The silvicultural method of claim 33 wherein the step of applying a woody herbicide is delayed for at least two years following the step comprising defining said at least one infiltration zone.
